(19) United States
(12) Patent Application Publication
(10) Pub. No.: US 2006/0151538 A1
(43) Pub. Date: Jul. 13, 2006

(54) Dispencing device

(76) Inventor: Edgar Ivo Maria Van Der Heijden, Broek Op Langeduk (NL)

Correspondence Address: HOFFMANN & BARON, LLP, 6900 JERICHO TURNPIKE, SYOSSET, NY, 11791, US

(21) Appl. No.: 10/548,215

(22) PCT Filed: Apr. 4, 2004
(86) PCT No.: PCT/NL04/00160

§ 371 Date: Jan. 18, 2006

(30) Foreign Application Priority Data
Mar. 4, 2003 (NL) 022841

(51) Int. Cl. B67D 5/58

(52) U.S. Cl. 222/190

(57) ABSTRACT

The invention relates to a dispensing device (1) comprising a dispensing opening (10) and a reservoir (10) holding a liquid substance (4) which comprises one or more fragrances, such as a perfume, eau de toilette, aftershave or the like, which is intended to be applied to part of the skin in order to spread a specific smell. The dispensing device is characterized in that it comprises a dispensing assembly (3) for forming the liquid substance into a foam and for dispensing the foam, which foam can be applied to part of the skin, the liquid substance comprising foaming agents for forming the liquid substance into a foam. Furthermore, the invention relates to a liquid substance, such as a perfume, eau de toilette, aftershave or the like, the liquid substance comprising foaming agents for forming the liquid substance into a foam, and to a foam former for dispensing the liquid substance.

The invention relates to a dispensing device comprising a reservoir holding a liquid substance which comprises one or more fragrances, such as a perfume, eau de toilette, aftershave or the like, which is intended to be applied to part of the skin in order to spread a specific smell. The invention also relates to a liquid substance, such as a perfume, eau de toilette, aftershave or the like, and to the use of a foam former for dispensing a liquid substance of this type.

In practice, a small bottle which is provided with an opening for dispensing a liquid substance is used to apply a liquid substance, such as a perfume, eau de toilette, aftershave or the like, to the skin. The liquid substance, in order to be applied to the skin, has to be poured into one or both hands, after which it is applied to the skin, for example to part of the face, and distributed by means of the one or two hands.

One drawback of applying the liquid substance in this way is that it requires a large amount of relatively expensive liquid. It is difficult to meter the quantity of liquid which is placed onto the hand. A further drawback is that the low viscosity of the liquid substance means that it can easily run off the hand.

As an alternative, in practice use is made of aerosols which atomize the liquid substance, with this atomized liquid substance being applied direct to the skin.

The drawback of using atomizing aerosols or pump dispensers of this type is that it is not possible to use a fine mist, since a fine mist of this type can very easily become dispersed in the air and can also get into the user's eyes and/or onto the user's clothes, which is undesirable. In practice, therefore, a relatively poor atomizer is used, which produces an irregular mist with relatively large droplets. With an aerosol of this type, it is consequently difficult for the liquid substance to be accurately metered and distributed.

The object of the invention is to provide a dispensing device for dispensing a liquid substance which comprises one or more fragrances in accordance with the preamble of claim 1, which dispensing device allows accurate metering and easy application of a quantity of liquid substance, such as perfume, eau de toilette, aftershave or the like.

The object is achieved by a dispensing device which is characterized in that the dispensing device comprises a dispensing assembly for forming the liquid substance into a foam and for dispensing the foam, which foam can be applied to part of the skin, the liquid substance comprising foaming agents for forming the liquid substance into a foam.

The formation of a foam means that a relatively large volume of foam is dispensed compared to the quantity of liquid substance consumed to form it. This makes it possible to meter the volume dispensed with greater accuracy. In this context, it is possible for the larger volume to be applied to and distributed over the intended area of skin more easily. This is possible partly on account of the fact that the foam does not flow off the hand or skin immediately after it has been applied to it.

An additional advantage of the formation of a foam for the application of the liquid substance is that the odour of the liquid substance can be released successfully, since there is a large contact area between the air and the liquid substance in the foam.

The foaming agents comprise, for example, interacting surfactants and thickeners, as are known per se to the person skilled in the art.

By mixing the liquid substance with, for example, air, it is possible to bring about or promote the formation of foam, so that a foam can be dispensed by the dispensing device without there being any need for a propellant.

Therefore, the liquid substance preferably does not comprise any propellant.

It is preferable for the dispensing device to comprise a liquid pump and an air pump, which are actuated simultaneously by hand in order to pump the liquid substance and air, respectively. The liquid pump and the air pump are preferably a liquid piston pump and an air piston pump respectively, with each pump comprising a piston and a cylinder. The air and the liquid substance can be mixed with one another and formed into a foam using a dispensing device of this type and then dispensed.

The dispensing device advantageously comprises a mixing chamber for mixing the liquid substance and air. The use of a suitable mixing chamber promotes the mixing of the liquid substance and the air and therefore the formation of the foam. Mixing chambers of this type are known per se.

The formation of the foam from the liquid substance which has been mixed with air can advantageously be promoted by the provision of porous elements, such as screen elements or the like, in a dispensing passage of the dispensing device.

Furthermore, the invention relates to a liquid substance which comprises one or more fragrances, for example a perfume, eau de toilette, aftershave or the like, for application to part of the skin in order to spread a specific smell, the liquid substance comprising foaming agents for forming the liquid substance into a foam. A foam of this type is relatively simple to meter and easy to apply to the skin compared to the liquids which are known from the prior art.

The liquid substance is preferably substantially soap-free. More preferably, the liquid substance is completely soap-free. The term soap is to be understood as meaning a substance which comprises one or more salts, such as for example sodium and/or potassium, and one or more fatty acids, such as for example oleic acid, stearic acid and/or palmitic acid. Soaps are generally used as cleansers.

The liquid substance advantageously comprises at least 2%, preferably at least 4%, of fragrances. More preferably, the liquid substance comprises at least 5%, and yet more preferably at least 10%, of fragrances. In practice, quantities of fragrances of this level have proven suitable for the formation of a liquid substance which is suitable for use as a perfume, aftershave, eau de toilette and the like.

The liquid substance preferably comprises:

50%-95% of carrier substances, such as an alcohol, in particular ethanol or water or mixtures thereof,

0.01%-15% of thickeners, preferably polymers which may optionally form a colloidal solution in water, such as polyethylene glycol and polypropylene glycol, polyacrylates or derivatives thereof,

1%-15% of surfactants, such as ethoxylated and propoxylated lanolin oil derivatives or EDTA, and

at least 1%, more preferably at least 10%, even more preferably at least 20%, of synthetic or natural fragrances, such as for example esters, polycyclic compounds or essential oils.

As a further addition, the liquid substance may comprise antioxidants, preservatives, colorants, microbicides, medicaments or pigments.

The liquid substance can advantageously be dispensed using a dispensing device according to one or more of claims 1-8.

The invention will be explained in more detail below on the basis of an exemplary embodiment and with reference to the appended drawing, in which:

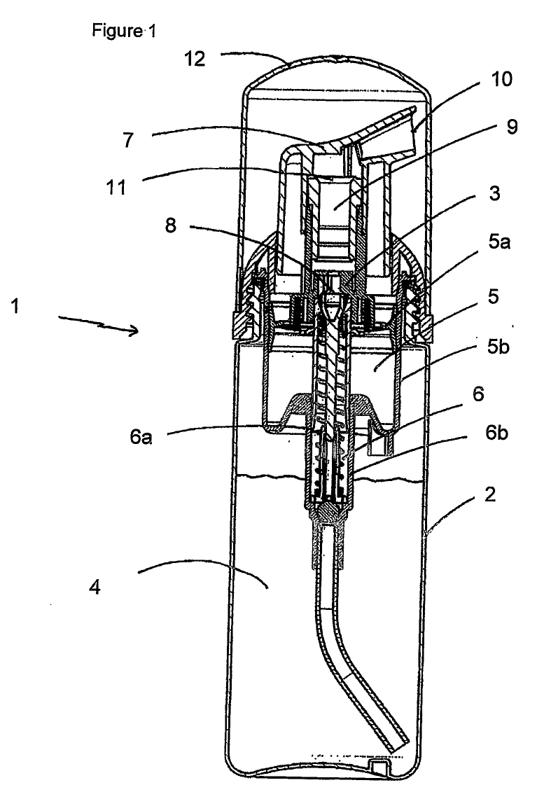

FIG. 1 shows a cross section through an embodiment of a dispensing device according to the invention.

FIG. 1 shows an embodiment of a dispensing device according to the invention, which is denoted overall by reference numeral 1.

The dispensing device 1 comprises a reservoir 2 and a dispensing assembly 3. The reservoir 2 is filled with a liquid substance 4 which contains one or more fragrances, for example a perfume, eau de toilette, aftershave or the like. Liquid substances 4 of this type are applied to part of the skin in order to spread a certain smell.

The dispensing assembly 3 comprises an air pump 5 and a liquid pump 6 for pumping air and liquid substance 4, respectively. The air pump and the liquid pump each have a piston 5a, 6a and a cylinder 5b, 6b, between which the air pump chamber and liquid pump chamber, respectively, are formed. Pumps of this type are known as piston pumps. However, it is also possible to use other suitable types of pumps.

The air pump 5 and the liquid pump 6 can be brought into action by a common actuating member 7 which can be actuated by hand. The air pump 5 of the embodiment of the dispensing device 1 shown is disposed coaxially with respect to the liquid pump 6.

The air and liquid substance 4 which are pumped by the air pump 5 and the liquid pump 6 are mixed with one another in a mixing chamber 8, so that a foam is formed. Then, the foam is dispensed through the dispensing opening 10 via a dispensing passage 9. At least one porous element 11 which promotes the formation of a foam from the liquid substance 4 mixed with air is arranged in the dispensing passage 9. The porous element 11 is preferably a disc-like screen element through which the mixture of air and liquid substance 4 flows. Furthermore, the dispensing device as shown comprises a cover 12 for shielding the dispensing assembly 3 when it is not in use.

In order to form the foam, the liquid substance 4 comprises foaming agents. These foaming agents comprise surfactants and thickeners.

The liquid substance 4 is preferably substantially soap-free, more preferably completely soap-free. Soap is a combination of one or more salts, for example sodium or potassium, and one or more fatty acids, for example oleic acid, stearic acid and/or palmitic acid. Soap is generally used as a cleanser. The liquid substance 4 is not intended and preferably not suitable for use as a cleanser.

The liquid substance 4 comprises at least 2% of fragrances, preferably at least 4% of fragrances. More preferably, the liquid substance comprises at least 5%, and even more preferably at least 10%, of fragrances. Such quantities of fragrances are suitable for liquid substances which are applied to the skin with a view to spreading a certain smell. A perfume comprises, for example, approximately 20-40% of fragrances, an eau de toilette 5-15% of fragrances, an aftershave 4-12% of fragrances and water 2-6% of fragrances.

Furthermore, it is also possible for the liquid substance 4 to comprise skincare agents or the like, or for the liquid substance to have additional skincare action, as is generally the case, for example, with aftershave.

The reservoir 2 of the dispensing device 1 is at least partially filled with the liquid substance 4. Actuation of the common actuating member 7 causes the liquid substance 4 which is pumped up to be mixed with air. This mixture forms a foam which is dispensed at the dispensing opening 10 via the dispensing passage 9.

The foam may, for example, be collected in a hand and then applied to the intended skin, for example part of the face, by this hand or using both hands. On account of the fact that the liquid substance 4 is dispensed in foam form, a relatively large volume is released, so that metering and distribution are relatively easy. Moreover, the fact that the liquid substance 4 is in foam form means•that the odour of the fragrances is released successfully.

The above text has described a possible embodiment of a dispensing device 1 according to the invention. However, it is also possible for the liquid substance according to the invention to be formed into a foam using a different type of foam former. The use of other types of foam formers which are suitable for forming the liquid substance 4 according to the invention into a foam, such as for example aerosols with a pressurized reservoir, squeeze foamers and a dispensing device which dispenses a gel which forms a foam after it has been dispensed (postfoaming gel), is also deemed to be encompassed by the invention.

The following text will give three examples of compositions which can be used as liquid substance in the dispensing device as described above; the percentages are percent by weight.

### EXAMPLE 1

| | |
|---|---|
| Deionized water | 60-80% |
| Alcohol | 20-30% |
| Acetylated lanolin alcohol | 1.0-3.6% |
| Alkoxylated methyl glucose derivative | 0.1-1.5% |
| Alkoxylated lanolin derivative | 1.2-3.2% |
| Fragrances | 5-15% |

### EXAMPLE 2

| | |
|---|---|
| Deionized water | 40-50% |
| Foaming eau de cologne concentrate | 27-29% |
| Alcohol | 20-24% |
| Silicone polyether (glycol) copolymer (DOW | 1.5-2.0% |
| Corning 193) | |
| Methylisothiazolinone (Kathon CG) | 0.05-0.1% |

### EXAMPLE 3

| | |
|---|---|
| Deionized water | 45-60% |
| Alcohol | 20-25% |
| Thickeners (polyethylene glycol, polypropylene | 2-8% |
| glycol, polyacrylates or derivatives thereof) | |
| Surfactants (ethoxylated and propoxylated | 3-5% |
| lanolin oil derivatives or EDTA) | |
| Fragrances (esters, polycyclic compounds or | 15-25% |
| essential oils) | |

1-20. (canceled)

21. A dispensing device comprising a dispensing opening and a reservoir holding a liquid substance which comprises one or more fragrances, such as a perfume, eau de toilette, aftershave or the like, which is intended to be applied to part of the skin in order to spread a specific smell, wherein the dispensing device comprises a dispensing assembly for forming the liquid substance into a foam and for dispensing the foam, which foam can be applied to part of the skin, the liquid substance comprising foaming agents for forming the liquid substance into a foam.

22. The dispensing device of claim 21, wherein the liquid substance is substantially soap-free.

23. The dispensing device of claim 21, wherein the liquid substance is completely soap-free.

24. The dispensing device of claim 21, wherein the liquid substance comprises at least 2% of fragrances, preferably at least 4%.

26. The dispensing device of claim 21, wherein the dispensing device comprises a liquid pump and an air pump which can be simultaneously actuated by hand in order to pump the liquid substance and air, respectively.

27. The dispensing device of claim 21, wherein the dispensing device comprises a mixing chamber for mixing the liquid substance and air.

28. The dispensing device of claim 21, wherein the dispensing device, in a dispensing passage, comprises one or more porous elements, such as one or more screen elements or the like, for promoting the formation of a foam from liquid substance which has been mixed with air.

29. A liquid substance, such as a perfume, eau de toilette, aftershave or the like, for application to part of the skin in order to spread a specific smell, comprising one or more fragrances, the liquid substance comprising foaming agents for forming the liquid substance into a foam.

30. The liquid substance of claim 29, which is substantially soap-free, preferably completely soap-free.

31. The liquid substance of claim 29, which comprises at least 2% of fragrances, preferably at least 4% of fragrances.

32. The liquid substance of claim 29, which comprises at least 10%, more preferably at least 20%, of fragrances.

33. The liquid substance of claim 29, which comprises skincare agents.

34. The liquid substance of claim 29, in which the liquid substance is an aftershave, perfume or eau de toilette.

35. The liquid substance of claim 29, in which the foam can be dispensed using the dispensing device according to one or more of claims 1.

36. The liquid substance of claim 29, which comprises:
50%-95% of carrier substances, such as an alcohol, in particular ethanol or water or mixtures thereof,
0.01%-15% of thickeners, preferably polymers which may optionally form a colloidal solution in water, such as polyethylene glycol and polypropylene glycol, polyacrylates or derivatives thereof,
1%-15% of surfactants, such as ethoxylated and propoxylated lanolin oil derivatives or EDTA, and
at least 1%, more preferably at least 10%, even more preferably at least 20%, of synthetic or natural fragrances, such as for example esters, polycyclic compounds or essential oils.

37. The liquid substance of claim 29, which comprises, as a further addition, antioxidants, preservatives, colorants, microbicides, medicaments or pigments.

38. The liquid substance of claim 29, which does not contain any propellant.

39. The liquid substance of claim 29, in which the foaming agents comprise surfactants and thickeners.

40. Use of a foam former for dispensing the liquid substance of claim 29.

41. Dispensing device comprising a dispensing opening and a reservoir holding a liquid substance which comprises one or more fragrances, and which is intended to be applied to part of the skin,
wherein the dispensing device comprises a liquid pump and an air pump which can be simultaneously actuated by hand in order to pump the liquid substance and air, respectively, for forming the liquid substance into a foam and for dispensing the foam, which foam can be applied to part of the skin, the liquid substance comprising foaming agents for forming the liquid substance into a foam,
wherein the liquid substance is an aftershave, perfume or eau de toilette and comprises at least 5% of fragrances.

42. The dispensing device of claim 41, wherein the liquid substance comprises at least 10%, preferably at least 20%, of fragrances.

43. The dispensing device of claim 41, wherein said liquid substance comprises:
50%-95% of carrier substances, such as an alcohol, in particular ethanol or water or mixtures thereof,
0.01%-15% of thickeners, preferably polymers which may optionally form a colloidal solution in water, such as polyethylene glycol and polypropylene glycol, polyacrylates or derivatives thereof,
1%-15% of surfactants, such as ethoxylated and propoxylated lanolin oil derivatives or EDTA, and
at least 5%, preferably at least 10%, more preferably at least 20%, of synthetic or natural fragrances, such as for example esters, polycyclic compounds or essential oils.

44. Use of the dispensing device of claim 41 for dispensing an aftershave, perfume or eau de toilette in the form of a foam.
